(19) United States
(12) Patent Application Publication
(10) Pub. No.: US 2026/0196406 A1
(43) Pub. Date: Jul. 9, 2026

(54) MANUFACTURING METHOD OF RE-FE-B BASED SINTERED MAGNET AND RE-FE-B BASED SINTERED MAGNET MANUFACTURED THROUGH THE METHOD

(71) Applicant: Daegu Gyeongbuk Institute of Science and Technology, Daegu (KR)

(72) Inventors: Dong Hwan KIM, Daegu (KR); Jeong Min KIM, Daegu (KR); Seong Chan KIM, Jinju-si (KR)

(73) Assignee: Daegu Gyeongbuk Institute of Science and Technology, Daegu (KR)

(21) Appl. No.: 19/013,456

(22) Filed: Jan. 8, 2025

(51) Int. Cl. H01F 41/02; B22F 3/105; H01F 1/057

(52) U.S. Cl. CPC H01F 41/0293; H01F 1/0577; B22F 2003/1051; B22F 2202/13; B22F 2304/10

(57) ABSTRACT

The present invention discloses a method for manufacturing an RE-Fe—B-based sintered magnet and the RE-Fe—B-based sintered magnet manufactured using the method. The invention comprises: a step of preparing a mixed powder by mixing magnet powder containing RE-Fe—B-based grains with a heavy rare earth diffusion source, a step of pressing the mixed powder to produce a compact, a step of performing spark plasma sintering (SPS) on the compact to form a sintered body, and a step of heating the sintered body to diffuse the heavy rare earth diffusion source into the grain boundaries of the sintered body, wherein the grain size of the RE-Fe—B-based grains is controlled during the step of forming the sintered body.

### BACKGROUND OF THE DISCLOSURE

### Field of the Disclosure

Example embodiments relate to a method for manufacturing an RE-Fe—B-based sintered magnet. More specifically, the present invention pertains to a method for manufacturing an RE-Fe—B-based sintered magnet, characterized by having high coercivity by spark plasma sintering (SPS) a mixed powder prepared by mixing magnet powder containing RE-Fe—B-based grains with a heavy rare earth diffusion source, and an RE-Fe—B-based sintered magnet manufactured thereby.

### Description of the Related Art

Recently, with the rapid emergence of energy-saving and environmentally friendly green growth projects as a new issue, the automotive industry has been actively researching hybrid vehicles, which use internal combustion engines powered by fossil fuels in conjunction with motors, as well as fuel cell vehicles, which utilize alternative energy sources such as hydrogen to generate electricity to drive motors.

These environmentally friendly vehicles commonly operate using electrical energy, making it essential to adopt motors and generators employing sintered magnets. From the perspective of magnetic materials, there is a growing technological demand for rare earth sintered magnets with superior magnetic properties to further enhance energy efficiency.

In addition to drive motors, improving the fuel efficiency of environmentally friendly vehicles also involves achieving lightweight and compact designs for automotive components such as steering systems and electrical devices. For example, in the case of motors, lightweight and compact designs require multifunctional motor designs as well as replacing ferrite magnets with rare earth sintered magnets, which offer superior magnetic performance.

Traditionally, alloys used to manufacture permanent magnets have primarily been alnico and ferrite materials. However, with the advancement of miniaturization and high performance in electronics, communication, and mechanical components, Nd—Fe—B-based materials, which exhibit excellent magnetic properties, have been widely used in magnets.

Among RE-Fe—B-based sintered magnets, Nd—Fe—B magnets, developed and commercialized by Sumitomo Special Metals in Japan in 1982, are the most powerful sintered magnets with the highest maximum magnetic energy.

However, Nd—Fe—B magnets have the disadvantage of poor thermal properties, which cause a significant reduction in coercivity at high temperatures, rendering them unsuitable for use as sintered magnets.

The magnetic properties of rare earth sintered magnets may be expressed by residual flux density (Br) and coercivity (HcJ). Residual flux density is determined by the grain fraction, density, and magnetic alignment of the rare earth sintered magnets, while coercivity is related to their microstructure and is influenced by grain refinement or the uniform distribution of grain boundary phases.

To enhance coercivity, technologies for refining the particle size of the materials used in manufacturing rare earth sintered magnets have been developed. However, excessive particle refinement leads to increased oxidation and manufacturing costs, making it impractical to reduce particle size indefinitely.

Furthermore, rare earth sintered magnets are prone to eddy current generation within the magnets due to their high conductivity and low resistivity, resulting in temperature increases. This rise in temperature may lead to a reduction in flux density or irreversible demagnetization, causing significant motor performance degradation.

To address these issues, technologies have been developed to improve coercivity by performing grain boundary diffusion of heavy rare earth diffusion sources such as dysprosium (Dy) or terbium (Tb) in sintered rare earth magnets.

However, during the grain boundary diffusion process, the heavy rare earth diffusion source applied to the magnet surface (e.g., by dip coating a slurry prepared by diluting the heavy rare earth diffusion source in ethanol) must diffuse through narrow grain boundaries within the magnet. This creates a problem as it becomes challenging to maintain uniform compositional distribution of the heavy rare earth diffusion source from the magnet surface to its core. During the initial stage of diffusion, the heavy rare earth diffusion source rapidly penetrates the surface, but as diffusion progresses inward, the speed slows, resulting in a magnet with a high concentration of heavy rare earth elements near the surface and almost none in the core, forming a non-uniform distribution.

Such non-uniform distribution of the heavy rare earth diffusion source within the sintered magnet causes severe residual stress inside the magnet and fails to sufficiently improve coercivity and thermal demagnetization properties from a magnetic performance perspective.

### SUMMARY

An objective of example embodiments is to address the issues of sintered magnets caused by the non-uniform diffusion of heavy rare earth diffusion sources applied for magnetic properties in conventional methods. Specifically, the present invention provides a method for manufacturing RE-Fe—B-based sintered magnets and RE-Fe—B-based sintered magnets manufactured thereby, capable of effectively diffusing heavy rare earth elements within the magnet to enhance the coercivity of rare earth sintered magnets.

An objective of example embodiments is to provide a method for manufacturing RE-Fe—B-based sintered magnets and RE-Fe—B-based sintered magnets manufactured thereby by utilizing a mixed powder of magnet powder containing RE-Fe—B-based grains and a heavy rare earth diffusion source. Through spark plasma sintering (SPS) and the grain boundary diffusion process (GBDP), the method effectively suppresses grain growth and uniformly distributes the grain boundaries, significantly improving the performance of RE-Fe—B-based sintered magnets.

Embodiments of the present invention provide a method for manufacturing an RE-Fe—B-based sintered magnet, comprising: mixing magnet powder containing RE-Fe—B-based grains with a heavy rare earth diffusion source to prepare a mixed powder, pressing the mixed powder to form a compact, performing spark plasma sintering (SPS) on the compact to form a sintered body, and heating the sintered body to diffuse the heavy rare earth diffusion source into the grain boundaries of the sintered body, wherein the grain size of the RE-Fe—B-based grains is controlled during the step of forming the sintered body.

The grain size of the RE-Fe—B-based grains may be controlled to be in the range of 2 μm to 5 μm by at least one of the pressure, temperature, and time of the spark plasma sintering.

The spark plasma sintering may be performed under a sintering pressure in the range of 30 MPa to 50 MPa.

The spark plasma sintering may be performed at a sintering temperature in the range of 600° C. to 800° C.

The spark plasma sintering may be performed for a sintering time in the range of 10 minutes to 20 minutes.

The step of preparing the mixed powder may comprise: preparing a heavy rare earth alloy using induction melting, performing hydrogen-disproportionation on the heavy rare earth alloy, performing desorption-recombination on the hydrogen-disproportionated heavy rare earth alloy, and pulverizing the dehydrogenated heavy rare earth alloy.

The step of pressing the mixed powder to form a compact may include a cold-pressing process or a magnetic field forming process.

The heavy rare earth diffusion source may be in an amount of 0.1 parts by weight to 1 part by weight relative to 100 parts by weight of the mixed powder.

The heavy rare earth diffusion source may include at least one of Nd, Pr, Dy, and Tb.

The step of heating the sintered body to diffuse the heavy rare earth diffusion source into the grain boundaries of the sintered body may comprise: a first heat treatment step performed at a heat treatment temperature in the range of 800° C. to 1000° C., and a second heat treatment step performed at a heat treatment temperature in the range of 400° C. to 600° C.

The heat treatment step may be performed for a heat treatment time in the range of 2 hours to 6 hours.

The density of the RE-Fe—B-based sintered magnet may be 97% to 99% of the theoretical density.

The RE-Fe—B-based sintered magnet may comprise a rare earth alloy phase in which the heavy rare earth diffusion source is diffused into the grain boundaries of the sintered body containing RE-Fe—B-based grains (wherein RE includes at least one of Nd, Pr, La, Ce, Y, Gd, Ho, Dy, and Tb).

The rare earth alloy phase may be represented by the following Chemical Formula 1:

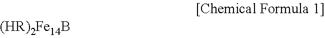

(wherein HR includes at least one of Nd, Pr, Dy, and Tb).

Embodiments of the present invention provide a method for manufacturing an RE-Fe—B-based sintered magnet, characterized by suppressing grain growth and achieving uniform distribution by using spark plasma sintering (SPS) and a grain boundary diffusion process (GBDP) with a mixed powder of magnet powder containing RE-Fe—B-based grains and a heavy rare earth diffusion source. The invention enables the production of RE-Fe—B-based sintered magnets with high coercivity and provides the RE-Fe—B-based sintered magnets manufactured by this method.

### BRIEF DESCRIPTION OF THE FIGURES

Embodiments will be described in more detail with regard to the figures, wherein like reference numerals refer to like parts throughout the various figures unless otherwise specified, and wherein:

FIG. 1 is a flowchart illustrating the method for manufacturing an RE-Fe—B-based sintered magnet according to embodiments.

FIG. 2 is a schematic diagram illustrating the method for manufacturing an RE-Fe—B-based sintered magnet according to an embodiment of the present invention.

FIG. 3 is a flowchart illustrating the method for preparing a heavy rare earth diffusion source during the step of preparing a mixed powder by mixing magnet powder containing RE-Fe—B-based grains and a heavy rare earth diffusion source S110.

FIG. 4 is a schematic diagram illustrating the interior of an RE-Fe—B-based sintered magnet according to an embodiment of the present invention.

FIG. 5 is a schematic diagram illustrating the structure and principle of the SPS sintering apparatus used in the method for manufacturing an RE-Fe—B-based sintered magnet according to an embodiment of the present invention.

FIG. 6 is a graph showing the density change of a sintered body (Example 1) after performing the spark plasma sintering (SPS) process in the method for manufacturing an RE-Fe—B-based sintered magnet according to an embodiment of the present invention.

FIG. 7 is a graph showing the change in coercivity of a sintered body (Example 1) after the SPS process and a sintered body (Example 2) after the heat treatment process in the method for manufacturing an RE-Fe—B-based sintered magnet according to an embodiment of the present invention.

FIG. 8 is a graph showing the density change of a sintered body (Example 1) after the SPS process and a sintered body (Example 2) after the heat treatment process in the method for manufacturing an RE-Fe—B-based sintered magnet according to an embodiment of the present invention.

FIG. 9 is a graph showing the change in coercivity of a sintered body (Example 1) after the SPS process and a sintered body (Example 2) after the heat treatment process in the method for manufacturing an RE-Fe—B-based sintered magnet according to an embodiment of the present invention.

FIG. 10 is a graph showing the change in coercivity of a sintered body (Example 1) after the SPS process, a sintered body (Example 2) after the heat treatment process, and a sintered body (Comparative Example 1) after the GBDP process in the method for manufacturing an RE-Fe—B-based sintered magnet according to an embodiment of the present invention.

FIG. 11 is a graph showing the change in coercivity of a sintered body (Example 1) after the SPS process, a sintered body (Comparative Example 1) after the GBDP process, and a sintered body (Example 3) after the GBiDP process in the method for manufacturing an RE-Fe—B-based sintered magnet according to an embodiment of the present invention.

### DETAILED DESCRIPTION OF THE DISCLOSURE

The following provides a detailed description of the embodiments of the present invention with reference to the accompanying drawings and the content described therein. However, the present invention is not limited or restricted to these embodiments.

The terms used herein are intended to describe the embodiments and not to limit the scope of the invention. In this specification, singular forms include plural forms unless explicitly stated otherwise. The terms “comprises” and/or “comprising” as used in the specification do not preclude the presence or addition of one or more other components or steps.

Terms such as “embodiment,” “example,” “aspect,” and “illustration” as used herein should not be interpreted as suggesting that a particular feature or design is preferred or advantageous over others.

Furthermore, the term “or” is intended to mean an inclusive logical OR rather than an exclusive logical OR, unless otherwise specified or explicitly stated in the context. For example, the expression “x uses a or b” is intended to mean any of the natural inclusive permutations, unless explicitly stated otherwise or evident from the context.

Singular terms such as “a” or “an” as used in the specification and claims should generally be interpreted to mean “one or more” unless explicitly stated otherwise or clear from the context.

The terminology used in the description below has been selected to be general and commonly understood in the relevant technical field. However, alternative terminology may exist due to technological advancements, conventions, or preferences of skilled artisans. Accordingly, the terminology used should not be interpreted as limiting the technical idea but as illustrative for explaining the embodiments.

In certain cases, specific terms have been arbitrarily chosen by the applicant, and their meaning will be clearly described in the relevant portions of the specification. Therefore, the terms used herein should be understood not merely by their literal names but by their meanings and the overall context of the specification.

Unless otherwise defined, all terms (including technical and scientific terms) used herein shall have meanings commonly understood by those skilled in the art to which the present invention pertains. Terms defined in generally used dictionaries should not be overly interpreted unless explicitly defined otherwise.

In describing the present invention, specific descriptions of known functions or configurations may be omitted when they would obscure the essence of the invention unnecessarily. The terminology used in this specification is intended to appropriately describe the embodiments of the present invention and may vary based on user preferences, operator intentions, or conventions in the relevant field. Accordingly, the definitions of such terms should be made based on the entire content of this specification.

The following description provides a preferred embodiment of the present invention with reference to the accompanying drawings.

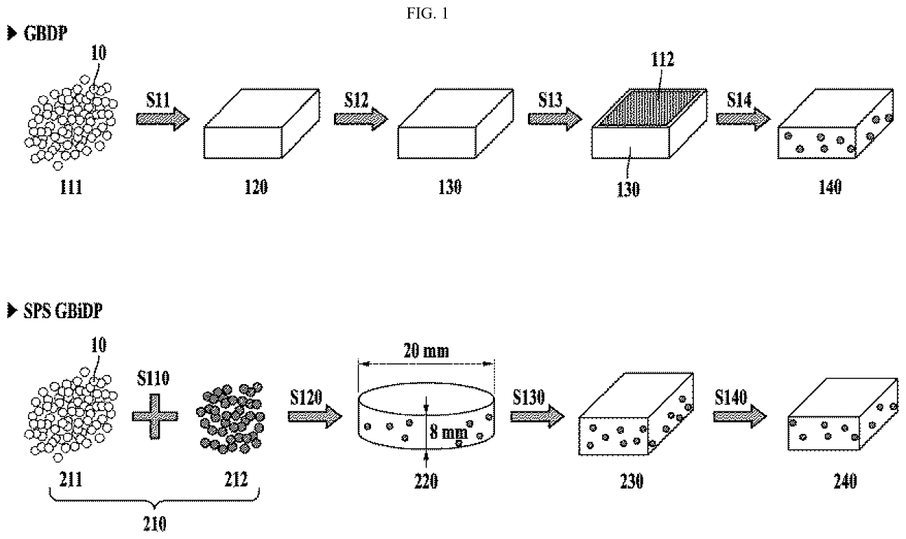

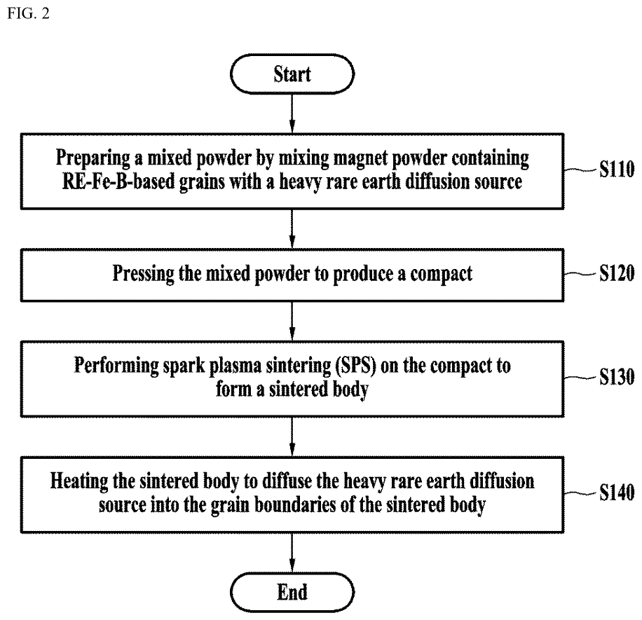

FIG. 1 is a schematic diagram illustrating the method for manufacturing an RE-Fe—B-based sintered magnet according to embodiments, and FIG. 2 is a flowchart illustrating the method for manufacturing an RE-Fe—B-based sintered magnet according to an embodiment of the present invention.

The conventional method for manufacturing an RE-Fe—B-based sintered magnet 140 comprises: a step S11 of pressing magnet powder 111 containing RE-Fe—B-based grains 10 to produce a compact 120, a step S12 of sintering the compact 120 to form a sintered body 130, a step (S13) of applying a heavy rare earth diffusion source 112 to the surface of the sintered body 130, and a step S14 of performing heat treatment to allow the heavy rare earth diffusion source 112 applied to the surface to diffuse into the interior of the sintered body 130.

However, the conventional RE-Fe—B-based sintered magnet 140 has a drawback in that the heavy rare earth diffusion source 112 is applied to the surface of the sintered body 130 and diffused into the interior through heat treatment, making it impossible to form a uniform grain boundary between the surface and the interior.

In contrast, the method for manufacturing an RE-Fe—B-based sintered magnet 240 according to an embodiment of the present invention comprises: a step S110 of preparing a mixed powder 210 by mixing magnet powder 211 containing RE-Fe—B-based grains 10 with a heavy rare earth diffusion source 212, a step S120 of pressing the mixed powder 210 to produce a compact 220, a step S130 of performing spark plasma sintering (SPS) on the compact 220 to form a sintered body 230, and a step S140 of performing heat treatment on the sintered body 230 to diffuse the heavy rare earth diffusion source 212 into the grain boundaries of the sintered body 230.

Therefore, the method for manufacturing an RE-Fe—B-based sintered magnet 240 according to an embodiment of the present invention employs the mixed powder 210 prepared by mixing magnet powder 211 containing RE-Fe—B-based grains 10 with a heavy rare earth diffusion source 212. This method utilizes an SPS GBiDP process in which spark plasma sintering (SPS) and grain boundary diffusion process (GBDP) occur simultaneously. In this process, the heavy rare earth diffusion source 212 diffuses along the grain boundaries within the magnet, resulting in uniform grain boundaries without diffusion depth limitations based on the thickness of the magnet. Additionally, the suppression of intragranular diffusion of the heavy rare earth diffusion source 212 enhances the magnetic properties and coercivity.

First, the method for manufacturing an RE-Fe—B-based sintered magnet 240 according to an embodiment of the present invention includes a step S110 of preparing a mixed powder 210 by mixing magnet powder 211 containing RE-Fe—B-based grains 10 with a heavy rare earth diffusion source 212.

The RE-Fe—B-based sintered magnet 240 may include magnet powder 211 containing RE-Fe—B-based grains, where RE comprises at least one of Nd, Pr, La, Ce, Y, Gd, Ho, Dy, and Tb.

In addition, the RE-Fe—B-based sintered magnet 240 may include magnet powder 211 comprising an RE-Fe-TM-B composition, where RE is present in 28 to 35 parts by weight, Fe in 60 to 70 parts by weight, TM in 0.5 to 2 parts by weight, and B in 0.5 to 5 parts by weight. The alloy may be prepared by weighing the starting materials RE, Fe, TM, and B to achieve the desired composition (TM includes at least one of Cu, Al, Zr, Co, and Ga).

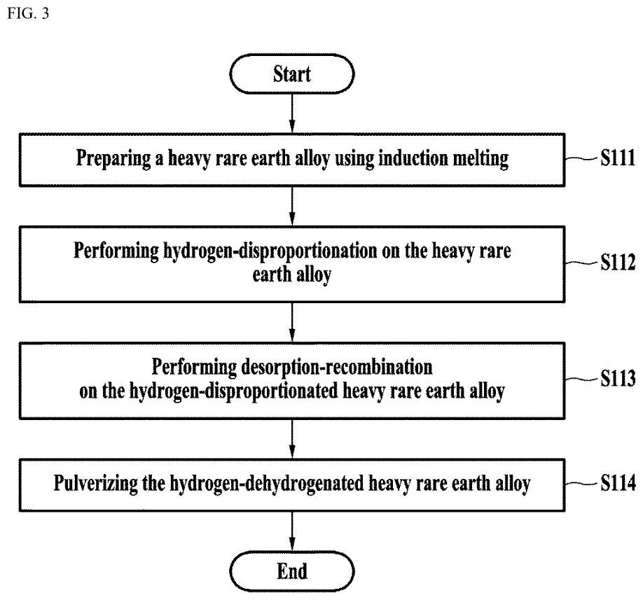

The method for preparing a heavy rare earth diffusion source during the step of preparing a mixed powder by mixing magnet powder containing RE-Fe—B-based grains with a heavy rare earth diffusion source will be described with reference to FIG. 3.

FIG. 3 is a flowchart illustrating the method for preparing a heavy rare earth diffusion source during the step of preparing a mixed powder by mixing magnet powder containing RE-Fe—B-based grains and a heavy rare earth diffusion source S110.

Referring to FIG. 3, the step S110 of preparing a mixed powder by mixing magnet powder containing RE-Fe—B-based grains with a heavy rare earth diffusion source may include: a step of preparing a heavy rare earth alloy using induction melting S111, a step of performing hydrogen-disproportionation on the heavy rare earth alloy S112, a step of performing desorption-recombination on the hydrogen-disproportionated heavy rare earth alloy, and a step of pulverizing the dehydrogenated heavy rare earth alloy.

In step S110, the preparation of the heavy rare earth alloy using induction melting S111 may be carried out.

Additionally, the alloying process using induction melting for manufacturing the heavy rare earth diffusion source may involve placing a dedicated crucible into a chamber, melting the material under an argon (Ar) atmosphere to prevent oxidation of the sample, and then casting the molten alloy into a copper (Cu) mold by tilting the vacuum induction melting furnace by 90° once the molten metal stabilizes.

In step S110, the process of performing hydrogen-disproportionation on the heavy rare earth alloy S112 may be carried out.

In step S112, the hydrogen-disproportionation process may include: loading the prepared heavy rare earth alloy into a designated chamber, forming a vacuum in the chamber, injecting hydrogen into the chamber, heating the chamber to a hydrogen disproportionation temperature in the range of 350° C. to 450° C. and maintaining the temperature for a predetermined period of time, and cooling the heavy rare earth alloy by injecting an inert gas into the chamber.

During the hydrogen disproportionation process, the heavy rare earth alloy is heated under a hydrogen atmosphere. As hydrogen penetrates into the alloy and expands, it may act as a mechanism to facilitate the pulverization of the alloy.

In step S110, the process of performing desorption-recombination on the hydrogen-disproportionated heavy rare earth alloy S113 may be carried out.

In step S113, the desorption-recombination process may include: forming a vacuum in the chamber, heating the chamber to a desorption-recombination temperature in the range of 500° C. to 600° C. and maintaining the temperature for a predetermined period (e.g., 10 hours), and cooling the alloy strips by injecting an inert gas into the chamber.

In step S110, the process of pulverizing the dehydrogenated heavy rare earth alloy S114 may be carried out.

In step S114, the method for manufacturing an RE-Fe—B-based sintered magnet according to embodiments of the present invention may include conducting the pulverization process using one of jet milling, attritor milling, ball milling, vibratory milling, basket milling, hand milling, or hydrogen decrepitation (HDDR). Preferably, ball milling or jet milling processes may be utilized.

The step S114 of pulverizing the dehydrogenated heavy rare earth alloy may adjust the particle size distribution of the raw powder or the shape of each particle constituting the powder by appropriately modifying the pulverization or manufacturing conditions. While the shape of the particles is not particularly limited, it is advantageous to maintain the particles at a size close to that of a single domain within the magnet.

When the particles within the magnet achieve a size close to that of a single domain, magnetization reversal occurs solely through the rotation of the magnetic moment, without domain wall movement. In such cases, when an external magnetic field is applied under saturation conditions, significant energy is required to realign each magnetic domain in the opposite direction. Therefore, preserving the initial single-crystal RE-Fe—B magnet powder size as much as possible is crucial to enhancing coercivity.

The heavy rare earth diffusion source may be in an amount of 0.1 parts by weight to 1 part by weight relative to 100 parts by weight of the mixed powder.

If the heavy rare earth diffusion source is less than 0.1 parts by weight relative to 100 parts by weight of the mixed powder, it may be challenging to achieve a uniform grain boundary. Conversely, if the heavy rare earth diffusion source exceeds 1 part by weight relative to 100 parts by weight of the mixed powder, residual magnetization and magnetic properties may deteriorate due to the antiferromagnetic coupling between the heavy rare earth diffusion source (e.g., Tb) and iron (Fe).

The heavy rare earth diffusion source may include at least one of Nd, Pr, Dy, and Tb.

Preferably, the heavy rare earth diffusion source may include at least one of NdHx, PrHx, DyHx, HoHx, and TbHx (where x is the number of hydrogen atoms and 1≤x≤n). More preferably, the heavy rare earth diffusion source in the RE-Fe—B-based sintered magnet according to embodiments of the present invention may be characterized by including TbH.

When the number of hydrogen atoms in the heavy rare earth diffusion source varies (e.g., TbH and TbH₂), an increase in the number of hydrogen atoms generally stabilizes the material, potentially reducing the degree of oxidation.

The method for manufacturing an RE-Fe—B-based sintered magnet according to embodiments of the present invention may enhance magnetic properties using a small amount of heavy rare earth diffusion source (e.g., Tb) of 1 part by weight or less. This reduces waste of the heavy rare earth diffusion source, improves sinterability, and suppresses grain boundary decomposition.

Referring back to FIG. 1, the method for manufacturing an RE-Fe—B-based sintered magnet 240 according to embodiments of the present invention includes a step S120 of pressing the mixed powder 210 to produce a compact 220.

The step S120 of pressing the mixed powder 210 to produce a compact 220 may use cold pressing or a magnetic field forming process.

The magnetic field forming process involves compressing the mixed powder 210 within a magnetic field using a mold to obtain the compact 220. In contrast, cold pressing, unlike hot pressing, applies uniform pressure to the powder without heat treatment. This method involves placing the mixed powder 210 into a graphite mold and applying uniaxial pressure.

The RE-Fe—B-based sintered magnet 240 according to embodiments of the present invention may enhance magnetic properties by densifying the compact 220 using cold pressing to manufacture the compact 220.

The pressure applied during cold pressing may be in the range of 10 MPa to 50 MPa. If the pressure is less than 10 MPa, the filling density of the compact decreases, whereas pressures exceeding 50 MPa may lead to the destruction of the graphite mold.

The pressure application time for cold pressing may range from 10 seconds to 30 seconds.

Additionally, the compact 220 produced through step S120 of pressing the mixed powder 210 to form the compact 220 may have a diameter of 10 mm to 20 mm and a height of 6 mm to 8 mm.

The method for manufacturing an RE-Fe—B-based sintered magnet 240 according to embodiments of the present invention includes step S130, which involves performing spark plasma sintering (SPS) on the compact 220 to form a sintered body 230.

The spark plasma sintering (SPS) process enables rapid sintering at relatively low temperatures of 600° C. to 800° C. within a short duration of 10 to 20 minutes by applying pressure while a pulsed current flows through the powder, generating resistive heating. This suppresses grain growth within the RE-Fe—B-based sintered magnet 240, enhancing its magnetic properties.

In step S130, the SPS pressure may range from 30 MPa to 50 MPa. If the sintering pressure is below 30 MPa, the density of the sintered body decreases, whereas pressures exceeding 50 MPa may result in mold breakage.

The SPS sintering temperature in step S130 may range from 600° C. to 800° C. If the sintering temperature is below 600° C., the density of the sintered body 230 may decrease, whereas temperatures exceeding 800° C. may lead to excessive liquid phase generation, causing mold breakage, sintered body failure, and grain growth.

Additionally, the SPS sintering time in step S130 may range from 10 minutes to 20 minutes. If the sintering time is less than 10 minutes, insufficient sintering may lead to low density in the sintered body 230, whereas times exceeding 20 minutes may cause grain 10 growth.

In conventional methods for manufacturing RE-Fe—B-based sintered magnets 140, sintering has been performed using methods such as hot isostatic pressing (HIP) sintering, ultra-high pressure synthesis sintering, or gas pressure sintering. However, due to the slow heating rates, prolonged exposure to high temperatures often results in grain 10 growth, adversely affecting the magnetic properties.

In contrast, the method for manufacturing an RE-Fe—B-based sintered magnet 240 according to embodiments of the present invention includes a spark plasma sintering (SPS) process, which allows sintering at temperatures 200° C. to 500° C. lower and within a shorter time compared to conventional sintering methods.

Thus, step S130 of performing SPS on the compact 220 to form the sintered body 230 enables rapid temperature increases due to localized heating on particle surfaces. This suppresses grain growth in the starting material and allows the grain size of the RE-Fe—B-based grains 10 to be controlled within the range of 2 μm to 5 μm, enhancing the coercivity of the RE-Fe—B-based sintered magnet 240.

A conventional RE-Fe—B-based sintered magnet 140 manufactured using traditional sintering methods may have a grain size of 5 μm to 10 μm compared to the initial powder size of 1 μm to 3 μm, with a standard deviation of 0.1 μm to 1 μm.

In contrast, an RE-Fe—B-based sintered magnet 240 according to embodiments of the present invention may have a grain size of 2 μm to 5 μm compared to the initial powder size of 1 μm to 3 μm, with a standard deviation of 0.1 μm to 1 μm.

Accordingly, the RE-Fe—B-based sintered magnet 240 according to embodiments of the present invention may have more uniform grain sizes 10 compared to conventional RE-Fe—B-based sintered magnets 140.

The method for manufacturing an RE-Fe—B-based sintered magnet 240 according to embodiments of the present invention includes step S140, which involves heating the sintered body 230 to diffuse the heavy rare earth diffusion source 212 into the grain boundaries of the sintered body.

Step S140 may include a first heat treatment step performed at a heat treatment temperature of 800° C. to 1000° C. If the heat treatment temperature is below 800° C., diffusion may not occur properly as it is below the melting point of the heavy rare earth diffusion source 212. On the other hand, temperatures exceeding 1000° C. may result in abnormal grain 10 growth, columnar decomposition, and deterioration of magnetic properties.

The first heat treatment step is performed to uniformly diffuse the heavy rare earth diffusion source 212 within the RE-Fe—B-based sintered magnet 240.

Additionally, the duration of the first diffusion heat treatment in step S140 may range from 2 hours to 6 hours. If the heat treatment time is less than 2 hours, diffusion may not occur adequately due to insufficient diffusion time for the heavy rare earth diffusion source 212. If the heat treatment time exceeds 6 hours, intragranular diffusion of the heavy rare earth diffusion source 212 and grain 10 growth may occur.

Step S140 may also include a second heat treatment step conducted at a heat treatment temperature of 400° C. to 600° C.

The duration of the second diffusion heat treatment in step S140 may also range from 2 hours to 6 hours.

The second heat treatment step is performed after the first heat treatment step at a relatively lower temperature to improve the microstructure of the RE-Fe—B-based sintered magnet 240.

Although the short-duration SPS sintering process may suppress the diffusion of the heavy rare earth diffusion source 212, potentially leading to insufficient formation of continuous Nd-rich phases at the grain boundaries, the method for manufacturing an RE-Fe—B-based sintered magnet 240 according to embodiments of the present invention may enhance and stabilize the microstructure of the RE-Fe—B-based sintered magnet 240 by performing a heat treatment process following the short-duration SPS process, thereby improving coercivity.

Accordingly, the RE-Fe—B-based sintered magnet 240 according to embodiments of the present invention may be manufactured using the method described.

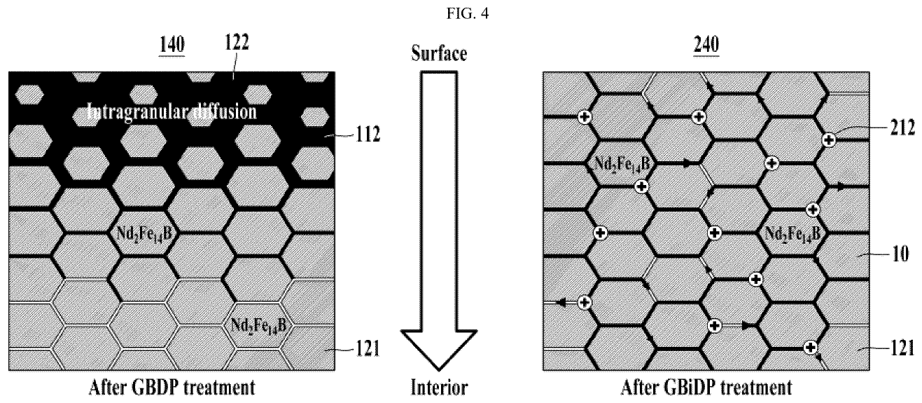

The RE-Fe—B-based sintered magnet 240 according to embodiments of the present invention will be described with reference to FIG. 4.

FIG. 4 is a schematic diagram illustrating the interior of an RE-Fe—B-based sintered magnet according to an embodiment of the present invention.

Generally, the interior of an RE-Fe—B-based sintered magnet 140, 240 consists of a structure where Nd₂Fe₁₄B main crystals, with a size of approximately 3 μm to 10 μm, are surrounded by grain boundary phases (with a thickness of approximately 10 nm to 100 nm, primarily composed of Nd, Fe, and O, and commonly referred to as the Nd-rich phase).

In conventional RE-Fe—B-based sintered magnets 140 manufactured by applying a typical heavy rare earth diffusion source 112 to the surface of the magnet and allowing it to diffuse into the interior, a large amount of the heavy rare earth diffusion source 112 tends to accumulate on the surface. This leads to intragranular diffusion into the interior but results in a relatively insufficient content of the heavy rare earth diffusion source 112 inside, causing a non-uniform distribution.

Therefore, in conventional RE-Fe—B-based sintered magnets 140 manufactured through the application of a heavy rare earth diffusion source 112, the heavy rare earth diffusion source 112 present on the surface may diffuse into the grain boundary 121 during the diffusion process. However, due to the prolonged heat treatment time, the heavy rare earth diffusion source 112 may form an enlarged grain boundary phase 122, which may degrade the magnetic properties.

In contrast, the RE-Fe—B-based sintered magnet 240 according to embodiments of the present invention is manufactured using SPS sintering and diffusion heat treatment (which may correspond to the grain boundary diffusion process, GBiDP) with a mixed powder 210 comprising magnet powder 211 containing RE-Fe—B-based grains 10 and a heavy rare earth diffusion source 212. Through this process, the heavy rare earth diffusion source 212 present within the magnet diffuses along the grain boundaries 121 internally, eliminating limitations on diffusion depth based on the thickness of the magnet. This enables uniform diffusion and grain boundaries 121, while the short heat treatment time suppresses grain 10 growth of the heavy rare earth diffusion source 212.

As a result, the RE-Fe—B-based sintered magnet 240 according to embodiments of the present invention achieves uniform diffusion of the heavy rare earth diffusion source 212 across the surface and interior of the magnet, ensuring a uniform content distribution in the thickness direction. This improves the quality of the magnet and increases coercivity by enhancing the content of the heavy rare earth diffusion source 212 at the center of the RE-Fe—B-based sintered magnet 240.

On the other hand, conventional RE-Fe—B-based sintered magnets 140, which are manufactured by applying a heavy rare earth diffusion source 112 to the surface of the sintered body and allowing it to diffuse into the interior, face challenges due to the dense surface structure or particle structure formed during the sintering process. This increased density inhibits effective diffusion of the surface-coated heavy rare earth diffusion source 112 in the thickness direction during the heat treatment process. Consequently, the heavy rare earth diffusion source 112 fails to diffuse uniformly throughout the entire structure of the conventional RE-Fe—B-based sintered magnet 140, resulting in limited improvements in coercivity.

In contrast, the RE-Fe—B-based sintered magnet 240 according to embodiments of the present invention allows for efficient diffusion in the thickness direction as diffusion progresses internally within the magnet. This enhances coercivity and increases the density of the RE-Fe—B-based sintered magnet 240.

Accordingly, the RE-Fe—B-based sintered magnet 240 according to embodiments of the present invention may achieve a density of 97% to 99% of the theoretical density.

The theoretical density refers to the maximum achievable density of a specific element, compound, or alloy, assuming no internal voids or impurities. It may vary depending on the RE-Fe—B composition. Generally, the theoretical density of Nd—Fe—B magnets may range from 7.4 g/cm³ to 7.7 g/cm³.

For example, if the theoretical density of an Nd—Fe—B magnet is 7.65 g/cm³, the RE-Fe—B-based sintered magnet 240 according to embodiments of the present invention may have a density of 7.4205 g/cm³ to 7.5735 g/cm³, corresponding to 97% to 99% of the theoretical density.

The RE-Fe—B-based sintered magnet 240 according to embodiments of the present invention includes a rare earth alloy phase in which the heavy rare earth diffusion source 212 is diffused into the grain boundaries 121 of the sintered body containing RE-Fe—B-based grains 10, where RE includes at least one of Nd, Pr, La, Ce, Y, Gd, Ho, Dy, and Tb. The rare earth alloy phase may be represented by Chemical Formula 1:

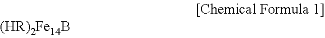

(Where HR includes at least one of Nd, Pr, Dy, and Tb.)

Additionally, the RE-Fe—B-based sintered magnet 240 according to embodiments of the present invention may include a rare earth alloy phase represented by Chemical Formula 2:

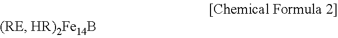

(Where HR includes at least one of Nd, Pr, Dy, and Tb, and RE includes at least one of Nd, Pr, La, Ce, Y, Gd, Ho, Dy, and Tb.)

For example, in the RE-Fe—B-based sintered magnet 240 according to embodiments of the present invention, during the heat treatment step for diffusing the heavy rare earth diffusion source 212 into the grain boundaries 121 of the sintered body, the diffusion of the heavy rare earth diffusion source 212 (e.g., Tb) causes the Nd in the Nd₂Fe₁₄B grains 10 and grain boundaries 121 to be replaced. As a result, a Tb₂Fe₁₄B phase may form on the surface of the grains 10 and in the grain boundaries 121, while the core of the grains 10 may predominantly consist of an Nd₂Fe₁₄B phase, and the shell may generally consist of a Tb₂Fe₁₄B phase.

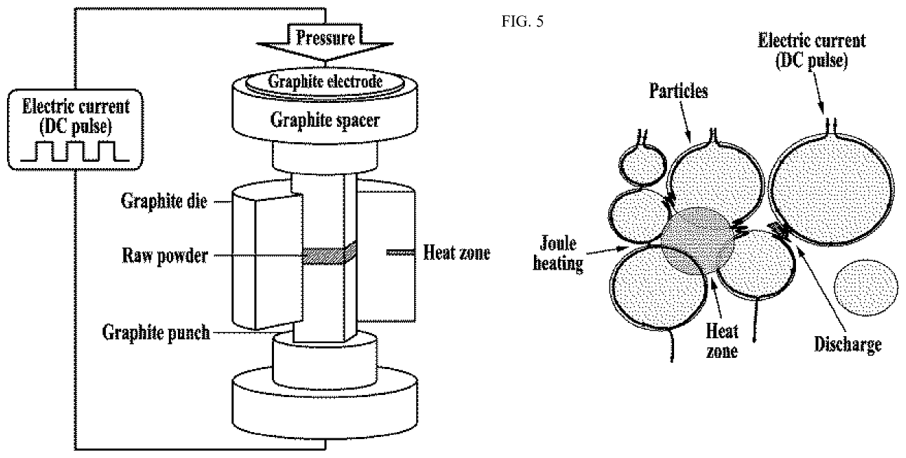

FIG. 5 is a schematic diagram illustrating the structure and principle of the SPS sintering apparatus used in the method for manufacturing an RE-Fe—B-based sintered magnet according to an embodiment of the present invention.

Referring to FIG. 5, the pressing sintering method utilizing direct current pulse discharge sintering applies a direct current pulse through electrodes to generate instantaneous discharge plasma. This plasma ensures that each particle inside the sintered body uniformly generates its own Joule heat, activating the particle surfaces and enabling simultaneous pressing and sintering.

The spark plasma sintering (SPS) method is a technique that uses plasma to synthesize or sinter materials within a short time. SPS involves directly applying pulsed electrical energy to the particle gaps of the compact, utilizing the high energy generated by the momentary high-temperature plasma (discharge plasma) from spark discharges. This process efficiently leverages heat diffusion and electric fields, enabling control of the sintering temperature from low temperatures up to over 2000° C. Compared to other sintering processes, SPS allows sintering or sintering-bonding within a short time frame, at sintering temperatures that are approximately 200° C. to 500° C. lower.

Moreover, the SPS method enables rapid temperature increases, suppressing grain growth, and allows for the fabrication of dense sintered bodies in a short time, even with materials that are difficult to sinter.

By mixing magnet powder containing RE-Fe—B-based grains with a heavy rare earth diffusion source, the mixed powder 210 is loaded into a mold installed in a chamber. A reducing gas is injected, and uniaxial pressure is applied with a punch while a direct current pulse is applied in a direction parallel to the pressing direction. During sintering, reactions occur between powder particles due to the applied pressure and the temperature increase caused by the high current, producing a sintered body.

During SPS, the pulse parameters were adjusted with a current of 1200 A, a pulse width of 150 ms for the ON state, and a current of 0 A with a pulse width of 10 ms for the OFF state. The temperature was raised to 750° C. and maintained for 5 minutes. If the current exceeds 1300 A, controlling the mold's internal temperature becomes challenging (exceeding the set temperature). Additionally, the internal temperature cannot be directly measured with thermocouples, potentially causing localized hotspots where the temperature exceeds the set level. These hotspots may result in the phase decomposition of the Nd₂Fe₁₄B phase into a soft magnetic α-Fe phase, reducing the magnetic properties.

The SPS process operates at lower sintering temperatures of 700° C. to 900° C. and requires a short sintering time of 3 to 15 minutes, enabling the production of high-density RE-Fe—B-based sintered magnets with fine and uniform microstructures.

Thus, the growth of grains in RE-Fe—B-based sintered magnets may be suppressed by adjusting at least one of the sintering conditions, including the process temperature, pressure, or holding time, during the SPS process.

### Manufacturing Examples

### Comparative Example 1: Sintered Magnet After GBDP

Jet-milled powder with a composition of RE 28 to 35 wt %, Fe 60 to 70 wt %, B 0.5 to 5 wt %, and TM 0.5 to 2 wt % (RE includes at least one of Nd and Pr, and TM includes at least one of Cu, Al, Zr, and Co) and a particle size of 1 to 3 μm was used.

10 g of NdFeB powder was placed into a mold and subjected to cold pressing. Subsequently, the powder was sintered using an SPS process at 750° C., 50 MPa, and a holding time of 5 minutes, producing a sintered body with a density of 7.45 g/cm³ or higher.

Heat treatment was performed to form grain boundaries that had not been created during the SPS sintering process. This involved heat treatment at 1000° C. for 2 hours, followed by heat treatment at 450° C. for 2 hours. Tb was used as the heavy rare earth diffusion source, and Tb powder was prepared through induction melting, hydrogen disproportionation, and pulverization processes.

A slurry of Tb was prepared by mixing the Tb powder with ethanol, and the SPS magnet was dip-coated with 1 wt % of the Tb slurry. GBDP heat treatment was then performed at 850° C. for 6 hours and 450° C. for 3 hours to produce the GBDP sintered magnet.

### Example 1: Sintered Magnet After SPS

Jet-milled powder with a composition of RE 28 to 35 wt %, Fe 60 to 70 wt %, B 0.5 to 5 wt %, and TM 0.5 to 2 wt % (RE includes at least one of Nd and Pr, and TM includes at least one of Cu, Al, Zr, and Co) and a particle size of 1 to 3 μm was used.

10 g of NdFeB powder was placed into a mold and subjected to cold pressing. Subsequently, the powder was sintered using an SPS process at 750° C., 50 MPa, and a holding time of 5 minutes, producing a sintered body with a density of 7.45 g/cm³ or higher.

### Example 2: Sintered Magnet After Heat Treatment

Jet-milled powder with a composition of RE 28 to 35 wt %, Fe 60 to 70 wt %, B 0.5 to 5 wt %, and TM 0.5 to 2 wt % (RE includes at least one of Nd and Pr, and TM includes at least one of Cu, Al, Zr, and Co) and a particle size of 1 to 3 μm was used.

10 g of NdFeB powder was placed into a mold and subjected to cold pressing. Subsequently, the powder was sintered using an SPS process at 750° C., 50 MPa, and a holding time of 5 minutes, producing a sintered body with a density of 7.45 g/cm³ or higher.

Heat treatment was performed to form grain boundaries that had not been created during the SPS sintering process. This involved heat treatment at 1000° C. for 2 hours, followed by heat treatment at 450° C. for 2 hours.

### Example 3: Sintered Magnet After GBiDP

Jet-milled powder with a composition of RE 28 to 35 wt %, Fe 60 to 70 wt %, B 0.5 to 5 wt %, and TM 0.5 to 2 wt % (RE includes at least one of Nd and Pr, and TM includes at least one of Cu, Al, Zr, and Co) and a particle size of 1 to 3 μm was used.

Tb was used as the heavy rare earth diffusion source, and Tb powder was prepared through induction melting, hydrogen disproportionation, and pulverization processes. 10 g of NdFeB powder and 1 wt % of TbH powder were mixed using a ball milling process. The mixed powder was placed into a mold and subjected to cold pressing.

Subsequently, the powder was sintered using an SPS process at 750° C., 50 MPa, and a holding time of 5 minutes, producing a sintered body with a density of 7.45 g/cm³ or higher. Heat treatment and the GBDP process were performed simultaneously, involving heat treatment at 1000° C. for 2 hours and 450° C. for 2 hours.

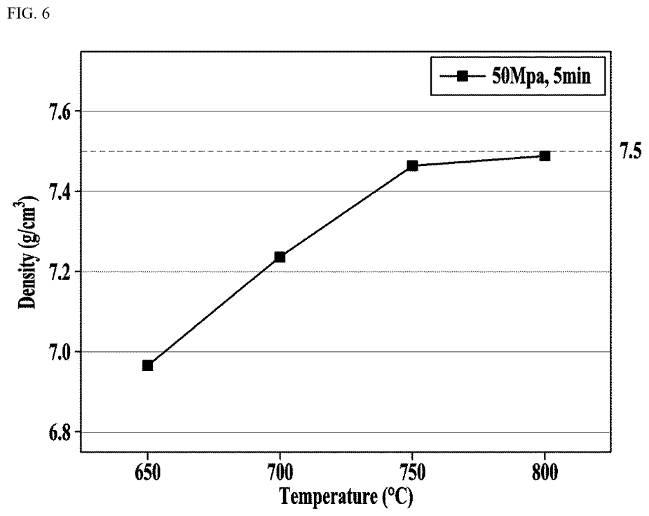

FIG. 6 is a graph showing the density change of a sintered body (Example 1) after performing the spark plasma sintering (SPS) process in the method for manufacturing an RE-Fe—B-based sintered magnet according to an embodiment of the present invention.

Referring to FIG. 6, the density of the RE-Fe—B-based sintered magnet may reach 97% to 99% of the theoretical density when the sintering process temperature for manufacturing the sintered body by performing spark plasma sintering (SPS) on the compact is in the range of 750° C. to 800° C.

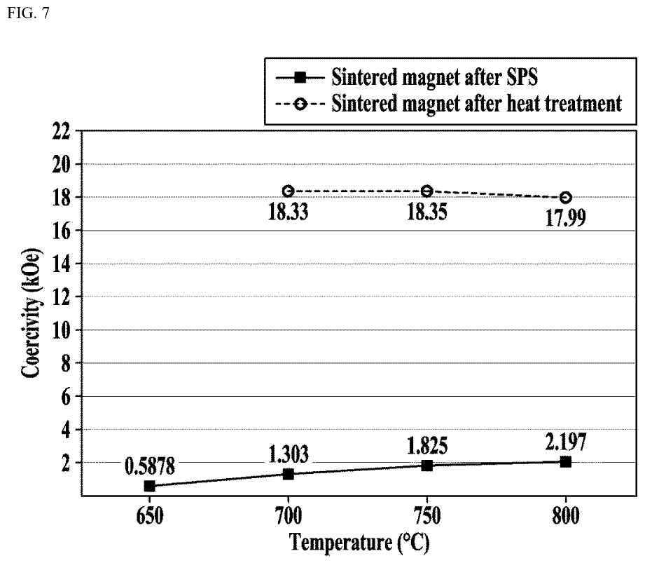

FIG. 7 is a graph showing the change in coercivity of a sintered body (Example 1) after the SPS process and a sintered body (Example 2) after the heat treatment process in the method for manufacturing an RE-Fe—B-based sintered magnet according to an embodiment of the present invention.

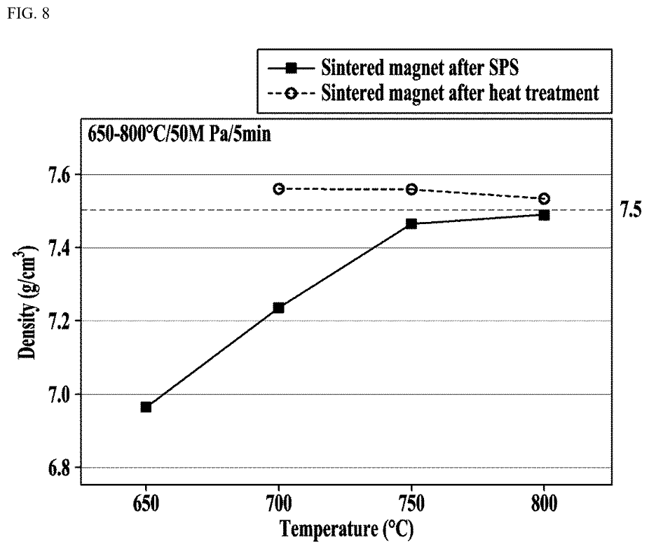

FIG. 8 is a graph illustrating the density changes of the sintered body (Example 1) after the spark plasma sintering (SPS) process and the sintered body (Example 2) after the heat treatment process in the method for manufacturing an RE-Fe—B-based sintered magnet according to embodiments of the present invention.

Referring to both FIG. 7 and FIG. 8, it may be characterized that the sintered bodies (Example 1) after the SPS process and (Example 2) after the heat treatment process show improvements in both density and coercivity.

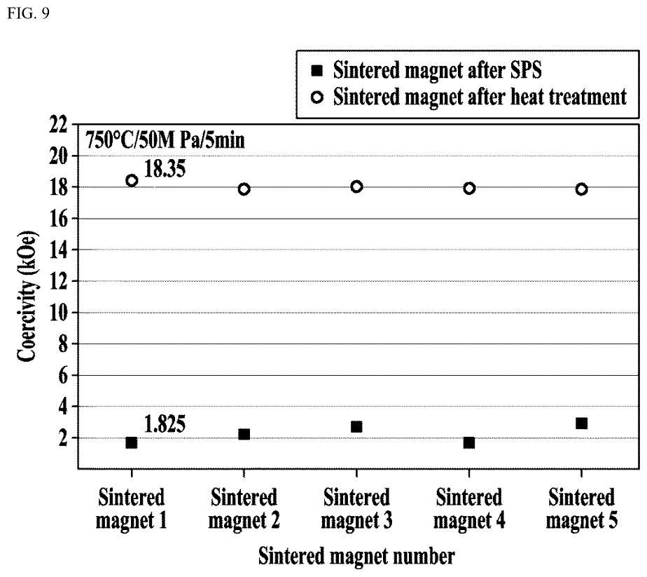

FIG. 9 is a graph showing the change in coercivity of a sintered body (Example 1) after the SPS process and a sintered body (Example 2) after the heat treatment process in the method for manufacturing an RE-Fe—B-based sintered magnet according to an embodiment of the present invention.

Referring to FIG. 9, the RE-Fe—B-based sintered magnet in Example 1 shows suppressed grain growth and limited diffusion due to the short sintering time of the spark plasma sintering (SPS) process. As a result, the coercivity of the RE-Fe—B-based sintered magnet immediately after the SPS process in Example 1 is relatively low because the formation of grain boundaries is not fully complete. However, through the heat treatment process in Example 2, diffusion occurs to form grain boundaries, leading to an increase in coercivity. Repeated experiments confirm that the results are highly reproducible.

Therefore, referring to FIGS. 6 through 9, the SPS process (Example 1) and the heat treatment process (Example 2) according to embodiments of the present invention may improve the coercivity and density of the RE-Fe—B-based sintered magnet at low temperatures (600° C. to 800°C.) and within a short time (10 to 20 minutes).

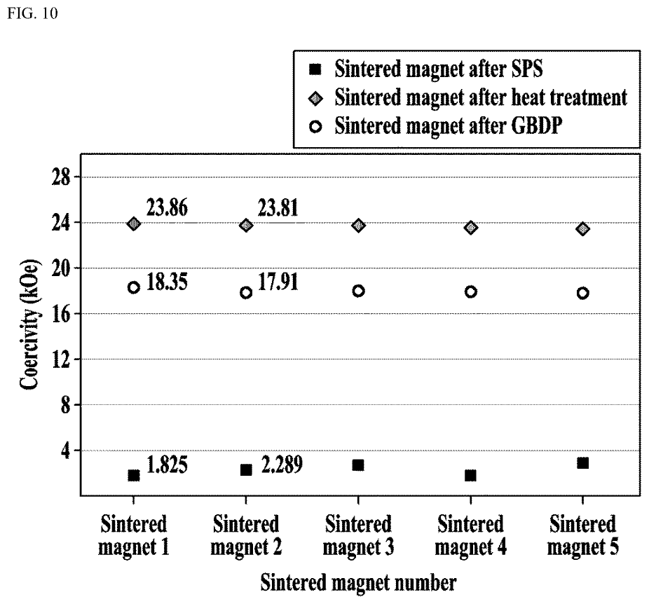

FIG. 10 is a graph illustrating the changes in coercivity of the sintered body (Example 1) after the spark plasma sintering (SPS) process, the sintered body (Example 2) after the heat treatment process, and the sintered body (Comparative Example 1) after the GBDP process in the method for manufacturing an RE-Fe—B-based sintered magnet according to embodiments of the present invention.

Referring to FIG. 10, the coercivity of the sintered magnet after the SPS process (Example 1) and the heat treatment process (Example 2), followed by the GBDP process with a dip coating of 1 wt % Tb, is shown to be 21 to 22.5 kOe. This indicates an improvement of 1 to 2 kOe in coercivity compared to the magnet after the heat treatment process (Example 2).

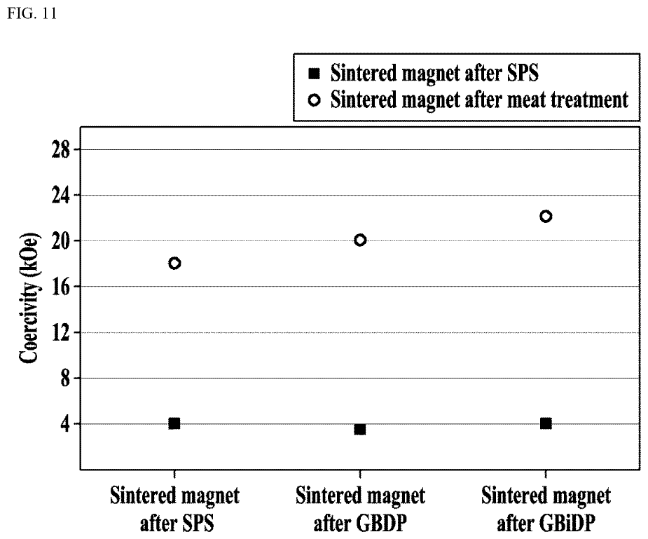

FIG. 11 is a graph illustrating the changes in coercivity of the sintered body (Example 1) after the spark plasma sintering (SPS) process, the sintered body (Comparative Example 1) after the GBDP process, and the sintered body (Example 3) after the GBiDP process in the method for manufacturing an RE-Fe—B-based sintered magnet according to embodiments of the present invention.

Referring to FIG. 11, it may be observed that the coercivity of the sintered body (Example 3) after the GBiDP process increased by 10% compared to the sintered body (Comparative Example 1) after the GBDP process under the same heat treatment conditions. The heavy rare earth diffusion source in the GBiDP sintered magnet, manufactured using the mixed powder, diffuses along the grain boundaries within the magnet, forming uniform grain boundaries and enhancing the coercivity of the RE-Fe—B-based sintered magnet.

If a sintered body is sintered at high temperatures for an extended period, grain growth (exceeding 1.5 times the initial powder size) or abnormal grain growth (exceeding twice the size of normal grains) may occur. This may result in non-uniform grain size distribution in the sintered magnet and degraded magnetic properties such as coercivity.

In particular, in cases of abnormal grain growth, misaligned grains that are not aligned along the magnetic easy-axis of the magnet tend to grow abnormally. This leads to reductions in both coercivity and remanent magnetization of the sintered magnet.

In contrast, the RE-Fe—B-based sintered magnet according to embodiments of the present invention utilizes a mixed powder containing RE-Fe—B-based grains and a heavy rare earth diffusion source. By employing a simultaneous spark plasma sintering (SPS) and grain boundary diffusion process (GBDP), the heavy rare earth diffusion source diffuses along the grain boundaries within the magnet, resulting in uniform grain boundaries. This method eliminates diffusion depth limitations based on the thickness of the magnet and suppresses grain boundary diffusion of the heavy rare earth diffusion source. Consequently, the magnetic properties and coercivity of the magnet are significantly improved.

As described above, although the present invention has been explained with reference to specific embodiments and drawings, it is not limited to the embodiments described herein. Those skilled in the art to which the present invention pertains will recognize that various modifications and alterations may be made based on the disclosed description. Therefore, the scope of the present invention should not be construed as being limited to the described embodiments but should be defined by the appended claims and their equivalents.

What is claimed is:

1. A method for manufacturing an RE-Fe—B-based sintered magnet, comprising:
mixing magnet powder containing RE-Fe—B-based grains with a heavy rare earth diffusion source to prepare a mixed powder;
pressing the mixed powder to form a compact;
performing spark plasma sintering (SPS) on the compact to form a sintered body; and
heating the sintered body to diffuse the heavy rare earth diffusion source into the grain boundaries of the sintered body;
wherein the grain size of the RE-Fe—B-based grains is controlled during the step of forming the sintered body.

2. The method of claim 1,
wherein the grain size of the RE-Fe—B-based grains is controlled to be in the range of 2 μm to 5 μm by at least one of the pressure, temperature, and time of the spark plasma sintering.

3. The method of claim 2,
wherein the spark plasma sintering is configured to be performed under a sintering pressure in the range of 30 MPa to 50 MPa.

4. The method of claim 2,
wherein the spark plasma sintering is configured to be performed at a sintering temperature in the range of 600° C. to 800° C.

5. The method of claim 2,
wherein the spark plasma sintering is configured to be performed for a sintering time in the range of 10 minutes to 20 minutes.

6. The method of claim 1,
wherein the step of preparing the mixed powder comprises:
preparing a heavy rare earth alloy using induction melting;
performing hydrogen-disproportionation on the heavy rare earth alloy; and
performing desorption-recombination on the hydrogen-disproportionated heavy rare earth alloy; and
pulverizing the hydrogen-dehydrogenated heavy rare earth alloy.

7. The method of claim 1,
wherein the step of pressing the mixed powder to form a compact is configured to include a cold-pressing process or a magnetic field forming process.

8. The method of claim 1,
wherein the heavy rare earth diffusion source is configured to be in an amount of 0.1 parts by weight to 1 part by weight relative to 100 parts by weight of the mixed powder.

9. The method of claim 1,
wherein the heavy rare earth diffusion source is configured to include at least one of Nd, Pr, Dy, and Tb.

10. The method of claim 1,
wherein the step of heating the sintered body is configured to diffuse the heavy rare earth diffusion source into the grain boundaries of the sintered body and comprises:
a first heat treatment step configured to be performed at a heat treatment temperature in the range of 800° C. to 1000° C.; and
a second heat treatment step configured to be performed at a heat treatment temperature in the range of 400° C. to 600° C.

11. The method of claim 1,
wherein the heat treatment step is configured to be performed for a heat treatment time in the range of 2 hours to 6 hours.

12. An RE-Fe—B-based sintered magnet configured to be manufactured according to claim 1.

13. The RE-Fe—B-based sintered magnet of claim 12,
wherein a density of the RE-Fe—B-based sintered magnet is configured to be 97% to 99% of the theoretical density.

14. The RE-Fe—B-based sintered magnet of claim 12,
wherein the RE-Fe—B-based sintered magnet comprises a rare earth alloy phase in which the heavy rare earth diffusion source is diffused into the grain boundaries of the sintered body containing RE-Fe—B-based grains (wherein RE includes at least one of Nd, Pr, La, Ce, Y, Gd, Ho, Dy, and Tb),
and the rare earth alloy phase is represented by the following Chemical Formula 1: 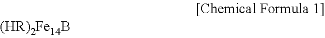
(wherein HR includes at least one of Nd, Pr, Dy, and Tb).
